(19) United States
(12) Patent Application Publication
(10) Pub. No.: US 2004/0071913 A1
(43) Pub. Date: Apr. 15, 2004

(54) Polyamide hoses for compressed air

(75) Inventor: Gaelle Bellet, Evreux (FR)

Correspondence Address: MILLEN, WHITE, ZELANO & BRANIGAN, P.C., 2200 CLARENDON BLVD., SUITE 1400, ARLINGTON, VA, 22201, US

(73) Assignee: ATOFINA, Puteaux (FR)

(21) Appl. No.: 10/609,666

(22) Filed: Jul. 1, 2003

(30) Foreign Application Priority Data
Jul. 1, 2002 (FR) 02.08185

(51) Int. Cl. B32B 1/08

(52) U.S. Cl. 428/36.91

(57) ABSTRACT

The present invention relates to a multilayer hose for compressed air, comprising:

an inner layer in contact with the compressed air, chosen from polyamides, polyamide/polyolefin blends with a polyamide matrix, copolymers having polyamide blocks and polyether blocks, and blends of polyamides with copolymers having polyamide blocks and polyether blocks;

an outer layer made of polyamide chosen from PA-11, PA-12, aliphatic polyamides resulting from the condensation of an aliphatic diamine having from 6 to 12 carbon atoms and of an aliphatic diacid having from 9 to 12 carbon atoms, and 11/12 copolyamides either having more than 90% nylon-11 units or more than 90% nylon-12 units.

According to a second embodiment, the invention relates to a mutilayer hose for compressed air, comprising:

an inner layer in contact with the compressed air, made of polyamide chosen from PA-11, PA-12, aliphatic polyamides resulting from the condensation of an aliphatic diamine having from 6 to 12 carbon atoms and of an aliphatic diacid having from 9 to 12 carbon atoms, and 11/12 copolyamides having either more than 90% nylon-11 units or more than 90% nylon-12 units;

an outer layer made of polyamide which is chosen from the same products as the inner layer and which may be the same or different;

at least one interlayer placed between the inner layer and the outer layer chosen from polyamide/polyolefin blends with a polyamide matrix, copolymers having polyamide blocks and polyether blocks, and blends of polyamides with copolymers having polyamide blocks and polyether blocks.

According to a variant of the invention, a reinforcing braid is placed between the inner layer and the outer layer. According to another variant of the invention, at least one tie layer is placed between the inner layer and the interlayer and/or between the interlayer and the outer layer.

### FIELD OF THE INVENTION

The present invention relates to polyamide hoses for compressed air. They are useful for delivering compressed air to equipment, machine tools, various devices and also for brake circuits in high-power vehicles.

Patent U.S. Pat. No. 6,066,377 discloses hoses for brake circuits. These hoses consist of an inner layer (in contact with the braking air) and of an outer layer made of polyamide, nylon-11 or nylon-12, and between these layers are one or two layers of high-density polyethylene (HDPE) and possibly a polyester reinforcing braid. The HDPE must be radiation-crosslinked so that the tube has mechanical strength, in particular burst strength, and it must contain a functionalized polyolefin in order to create adhesion between the polyamide and the HDPE. I have learned that the Examples are not reproducible and result in random results. Also, the mechanical properties of the HDPE are insufficient and weaken the tube.

Patent application FR 2 812 928 discloses layered tubing made of polyamide for air brakes, formed from outer and inner layers made of nylon-11 or nylon-12, with inner layers made of nylon-6 containing, by weight, 14% of a plasticizer (butylbenzenesulphonamide), 7% of residual caprolactam, 10% of maleic-anhydride-grafted EPDM elastomer and 5% of maleic-anhydride-grafted polyethylene. The nylon-6 and nylon-11 or nylon-12 layers are bonded together with a tie layer. The tie layer is preferably a nylon-6, 12 or an anhydride-modified polyolefin. I have learned that the plasticizer and the residual caprolactam of the PA-6 layers exude and cause delamination of the layers and stiffening of the PA-6 layers and that the hose no longer has sufficient mechanical properties. In addition, the nylon-6 has a much greater water uptake than PA-11 or PA-12 and therefore its mechanical properties are substantially degraded.

Polyamide-based hoses have now been found which do not have the above drawbacks, these consisting of several layers of polyamide and polamide-based blends. They are less expensive than the PA-11 or PA-12 monolayer hoses which are the standard, while still having the properties thereof.

The present invention relates to a multilayer hose for compressed air, comprising:

an inner layer in contact with the compressed air, chosen from polyamides, polyamide/polyolefin blends with a polyamide matrix, copolymers having polyamide blocks and polyether blocks, and blends of polyamides with copolymers having polyamide blocks and polyether blocks;

an outer layer made of polyamide chosen from PA-11, PA-12, aliphatic polyamides resulting from the condensation of an aliphatic diamine having from 6 to 12 carbon atoms and of an aliphatic diacid having from 9 to 12 carbon atoms, and 11/12 copolyamides either having more than 90% nylon-11 units or more than 90% nylon-12 units.

According to a variant of the invention, a reinforcing braid is placed between the inner layer and the outer layer.

According to another variant of the invention, a tie layer is placed between the inner layer and the outer layer.

According to another variant of the invention, other layers are placed between the inner layer and the outer layer.

According to another variant of the invention, two or more of these previous variants may be combined.

According to a second embodiment, the invention relates to a multilayer hose for compressed air, comprising:

an inner layer in contact with the compressed air, made of polyamide chosen from PA-11, PA-12, aliphatic polyamides resulting from the condensation of an aliphatic diamine having from 6 to 12 carbon atoms and of an aliphatic diacid having from 9 to 12 carbon atoms, and 11/12 copolyamides having either more than 90% nylon-11 units or more than 90% nylon-12 units;

an outer layer made of polyamide which is chosen from the same products as the inner layer and which may be the same or different;

at least one interlayer placed between the inner layer and the outer layer chosen from polyamide/polyolefin blends with a polyamide matrix, copolymers having polyamide blocks and polyether blocks, and blends of polyamides with copolymers having polyamide blocks and polyether blocks.

According to a variant of the invention, a reinforcing braid is placed between the inner layer and the outer layer.

According to another variant of the invention, at least one tie layer is placed between the inner layer and the interlayer and/or between the interlayer and the outer layer.

According to another variant of the invention, two or more of these previous variants may be combined.

With regard to the inner layer and firstly polyamides, the term “polyamide” is understood to mean products resulting from the condensation:

of one or more amino acids, such as aminocaproic, 7-aminoheptanoic, 11-aminoundecanoic and 12-aminododecanoic acid or of one or more lactams, such as caprolactam, oenantholactam and lauryllactam;

of one or more salts or mixtures of diamines such as hexamethylenediamine, dodecamethylenediamine, metaxylenediamine, bis(p-aminocyclohexyl)methane and trimethylhexamethylenediamine with diacids such as isophthalic, terephthalic, adipic, azelaic, suberic, sebacic and dodecanedicarboxylic acids.

As examples of polyamides, mention may be made of PA-6, PA-6,6, PA-11 and PA-12.

It may also be advantageous to use copolyamides. Mention may be made of the copolyamides resulting from the condensation of at least two alpha, omega-aminocarboxylic acids or of two lactams or of a lactam and of an alpha, omega-aminocarboxylic acid. Mention may also be made of the copolyamides resulting from the condensation of at least one alpha, omega-aminocarboxylic acid (or a lactam), at least one diamine and at least one dicarboxylic acid.

As examples of lactams, mention may be made of those which have from 3 to 12 carbon atoms on the main ring and are possibly substituted. Mention may be made, for example, of β,β-dimethylpropriolactam, α,α-dimethylpropriolactam, amylolactam, caprolactam, capryllactam and lauryllactam.

As examples of alpha, omega-aminocarboxylic acids, mention may be made of aminoundecanoic acid and aminododecanoic acid. As examples of dicarboxylic acids, mention may be made of adipic acid, sebacic acid, isopthalic acid, butanedioic acid, 1,4-cyclohexyldicarboxylic acid, terephthalic acid, the sodium or lithium salt of sulphoisophthalic acid, dimerized fatty acids (these dimerized fatty acids have a dimer content of at least 98% and are preferably hydrogenated) and dodecanedioic acid HOOC—(CH₂)₁₀—COOH.

The diamine may be an aliphatic diamine having from 6 to 12 carbon atoms; it may be a saturated cyclic and/or arylic diamine. As examples, mention may be made of hexamethylenediamine, piperazine, tetramethylenediamine, octamethylenediamine, decamethylenediamine, dodecamethylenediamine, 1,5-diaminohexane, 2,2,4-trimethyl-1,6-diaminohexane, diamine polyols, isophoronediamine (IPD), methylpentamethylenediamine (MPDM), bis(aminocyclohexyl)methane (BACM), and bis(3-methyl-4-aminocyclohexyl) methane (BMACM).

As examples of copolyamides, mention may be made of copolymers of caprolactam and lauryllactam (PA-6/12), copolymers of caprolactam, adipic acid and hexamethylenediamine (PA-6/6,6), copolymers of caprolactam, lauryllactam, adipic acid and hexamethylenediamine (PA 6/12/6,6), copolymers of caprolactam, lauryllactam, 11-aminoundecanoic acid, azelaic acid and hexamethylenediamine (PA-6/6,9/11112), copolymers of caprolactam, lauryllactam, 11-amino undecanoic acid, adipic acid and hexamethylenediamine (PA-616,6/11/12), and copolymers of lauryllactam, azelaic acid and hexamethylenediamine (PA-6,9/12).

Advantageously, the copolyamide is chosen from PA-6/12and PA-6/6,6.

It is also possible to use polyamide blends. Advantageously, the relative viscosity of the polyamides, measured as 1% solution in sulphuric acid at 20° C., is between 1.5 and 5.

With regard to the inner layer and the copolymers having polyamide blocks and polyether blocks these result from the copolycondensation of polyamide blocks having reactive ends with polyether blocks having reactive ends, such as, inter alia:

1) polyamide blocks having diamine chain ends with polyoxyalkylene blocks having dicarboxylic chain ends;

2) polyamide blocks having dicarboxylic chain ends with polyoxyalkylene blocks having diamine chain ends, obtained by cyanoethylation and hydrogenation of aliphatic dihydroxylated alpha, omega-polyoxyalkylene blocks called polyetherdiols;

3) polyamide blocks having dicarboxylic chain ends with polyetherdiols, the products obtained being, in this particular case, polyetheresteramides. Advantageously, these copolymers are used.

Polyamide blocks having dicarboxylic chain ends derive, for example, from the condensation of alpha, omega-aminocarboxylic acids, of lactams or of dicarboxylic acids and diamines in the presence of a chain-stopping dicarboxylic acid.

The polyether may, for example, be a polyethylene glycol (PEG), a polypropylene glycol (PPG) or a pqlytetramethylene glycol (PTMG). The latter is also called polytetrahydrofuran (PTHF).

The number-average molar mass Mₙ of the polyamide blocks is between 300 and 15000 and preferably between 600 and 5000. The mass Mn of the polyether blocks is between 100 and 6000 and preferably between 200 and 3000.

Polymers having polyamide blocks and polyether blocks may also include randomly distributed units. These polymers may be prepared by the simultaneous reaction of the polyether and polyamide-block precursors.

For example, it is possible to react polyetherdiol, a lactam (or an alpha, omega-amino acid) and a chain-stopping diacid in the presence of a small amount of water. A polymer is obtained having essentially polyether blocks and polyamide blocks of very variable length, but also the various reactants, having reacted in a random fashion, which are distributed randomly along the polymer chain.

These polymers having polyamide blocks and polyether blocks, whether they derive from the copolycondensation of polyamide and polyether blocks prepared beforehand or from a one-step reaction, have, for example, Shore D hardnesses which may be between 20 and 75 and advantageously between 30 and 70 and an intrinsic viscosity of between 0.8 and 2.5 measured in meta-cresol at 25° C. for an initial concentration of 0.8 g/100 ml. The MFIs may be between 5 and 50 (235° C., with a load of 1 kg).

The polyetherdiol blocks are either used as such and copolycondensed with polyamide blocks having carboxylic ends or they are aminated in order to be converted into diamine polyethers and condensed with polyamide blocks having carboxylic ends. They may also be mixed with polyamide precursors and a chain stopper in order to make polyamide-block and polyether-block polymers having randomly distributed units.

Polymers having polyamide and polyether blocks are described in Patents U.S. Pat. No. 4,331,786, U.S. Pat. No. 4,115,475, U.S. Pat. No. 4,195,015, U.S. Pat. No. 4,839,441, U.S. Pat. No. 4,864,014, U.S. Pat. No. 4,230,838 and U.S. Pat. No. 4,332,920.

The ratio of the amount of copolymer having polyamide blocks and polyether blocks to the amount of polyamide is, by weight, advantageously between 10/90 and 60/40.

With regard to the inner layer and the blends of a polyamide with copolymers having polyamide blocks and polyether blocks, these amount to replacing part of the polyamide with a copolymer having polyamide blocks and polyether blocks, that is to say using a blend comprising at least one of the above polyamides and at least one copolymer having polyamide blocks and polyether blocks. The copolymers having polyamide blocks and polyether blocks are defined above. Mention may be made, for example, of blends of (i) PA-6 and (ii) a copolymer having PA-6 blocks and PTMG blocks, blends of (i) PA-6 and (ii) a copolymer having PA-12 blocks and PTMG blocks, and blends of (i) PA-12 and (ii) a copolymer having PA-6 or PA-12 blocks and PTMG blocks.

As regards the polyolefin of the polyamide/polyolefin blend, this may be functionalized or unfunctionalized or may be a blend of at least one functionalized polyolefin and/or at least one unfunctionlized polyolefin. To simplify matters, polyolefins are denoted as (B) and functionalized polyolefins (B1) and unfunctionalized polyolefins (B2) are described below.

An unfunctionalized polyolefin (B2) is conventionally a homopolymer or an alpha-olefin or diolefin copolymer, such as, for example, ethylene, propylene, 1-butene, 1-octene and butadiene. By way of example, mention may be made of:

polyethylene homopolymers and copolymers, particularly LDPE, HDPE, LLDPE (linear low-density polyethylene), VLDPE (very low-density polyethylene) and metallocene polyethylene;

propylene homopolymers or copolymers;

ethylene/alpha-olefin copolymers, such as ethylene/propylene, EPR (the abbreviation for ethylene/propylene rubber) and ethylene/propylene/diene (EPDM);

styrene/ethylene-butene/styrene (SEBS), styrene/butadiene/styrene (SBS), styrene/isoprene/styrene (SIS) and styrene/ethylene-propylene/styrene (SEPS) block copolymers;

copolymers of ethylene with at least one product chosen from salts or esters of unsaturated carboxylic acids, such as alkyl (meth)acrylate (for example methyl acrylate), or vinyl esters of saturated carboxylic acids, such as vinyl acetate (EVA), the proportion of comonomer possibly being up to 40% by weight.

The functionalized polyolefin (B1) may be an alpha-olefin polymer having reactive groups (functional groups); such reactive groups are acid, anhydride or epoxy functional groups. As an example, mention may be made of the above polyolefins (B2) grafted or copolymerized or terpolymerized by unsaturated epoxides such as glycidyl methacrylate or by carboxylic acids or the corresponding salts or esters, such as (meth)acrylic acid (the latter possibly being completely or partially neutralized by metals such as Zn, etc.), or else by carboxylic acid anhydrides, such as maleic anhydride. A functionalized polyolefin is, for example, a PE/EPR blend, the weight ratio of which may vary widely, for example between 40/60 and 90/10, the said blend being cografted with an anhydride, especially maleic anhydride, with a grafting ratio of, for example, 0.01 to 5% by weight.

The functionalized polyolefin (B1) may be chosen from the following (co)polymers grafted with maleic anhydride or glycidyl methacrylate, in which the degree of grafting is, for example, from 0.01 to 5% by weight:

PE, PP, copolymers of ethylene with propylene, butene, hexene or octene, containing for example from 35 to 80% ethylene by weight;

ethylene/alpha-olefin copolymers, such as ethylene/propylene, EPR (the abbreviation for ethylene/propylene rubber) and ethylene/propylene/diene (EPDM);

styrene/ethylene-butene/styrene (SEBS), styrene/butadiene/styrene (SBS), styrene/isoprene/styrene (SIS) and styrene/ethylene-propylene/styrene (SEPS) block copolymers;

ethylene-vinyl acetate copolymers (EVA) containing up to 40% vinyl acetate by weight;

ethylene-alkyl (meth)acrylate copolymers containing up to 40% alkyl (meth)acrylate by weight; and

ethylene-vinyl acetate (EVA)/alkyl (meth)acrylate copolymers containing up to 40% by weight of comonomers.

The functionalized polyolefin (B1) may also be chosen from ethylene/propylene copolymers comprising predominantly propylene, these copolymers being grafted by maleic anhydride and then condensed with a monoamine polyamide (or a polyamide oligomer) (products described in EP-A-0 342 066).

The functionalized polyolefin (B1) may also be a copolymer or terpolymer of at least the following monomers: (1) ethylene; (2) an alkyl (meth)acrylate or a vinyl ester of a saturated carboxylic acid and (3) an anhydride, such as maleic anhydride or (meth)acrylic acid or epoxy such as glycidyl (meth)acrylate. As examples of functionalized polyolefins of the latter type, mention may be made of the following copolymers, in which ethylene preferably represents at least 60% by weight and in which the termonomer (the functional group) represents, for example, from 0.1 to 10% by weight of the copolymer:

ethylene/alkyl (meth)acrylate/(meth)acrylic acid or maleic anhydride or glycidyl methacrylate copolymers;

ethylene/vinyl acetate/maleic anhydride or glycidyl methacrylate copolymers; and

ethylene/vinyl acetate or alkyl (meth)acrylate/(meth)acrylic acid or maleic or glycidyl methacrylate anhydride copolymers.

In the above copolymers, the (meth)acrylic acid may be salified with Zn or Li.

The term “alkyl (meth)acrylate” in (B1) or (B2) denotes C1 to C8 alkyl acrylates and methacrylates, these possibly being chosen from methyl acrylate, ethyl acrylate, n-butyl acrylate, isobutyl acrylate, 2-ethyl hexylacrylate, cyclohexyl acrylate, methyl methacrylate and ethyl methacrylate.

Moreover, the aforementioned polyolefins (B1) may also be crosslinked by any process or suitable agent (diepoxy, diacid, peroxide, etc.); the term “functionalized polyolefin” also includes blends of the aforementioned polyolefins with a difunctional reactant, such as a diacid, dianhydride, diepoxy, etc., capable of reacting with them, or blends of at least two functionalized polyolefins which can react together.

The copolymers mentioned above, (B1) and (B2), may be random copolymers or block copolymers and have a linear or branched structure.

The molecular weight, the MFI and the density of these polyolefins may also vary widely, as a person skilled in the art will appreciate. MFI is the abbreviation for Melt Flow Index, which is measured according to the ASTM 1238 standard.

Advantageously, the unfunctionalized polyolefins (B2) are chosen from polypropylene homopolymers or copolymers and any ethylene homopolymer or copolymer of ethylene with a comonomer of the higher alpha-olefin type, such as butene, hexene, octene or 4-methyl-1-pentene. Mention may be made, for example, of PP, high-density PE, medium-density PE, linear low-density PE, low-density PE and very low-density PE. These polyethylenes are known to a person skilled in the art as being produced according to a “radical” process, using catalysis of the “Ziegler” type or, more recently, using catalysis referred to as “metallocene” catalysis.

Advantageously, the functionalized polyolefins (B1) are chosen from any polymer comprising alpha-olefin units and units carrying polar reactive functional groups, such as epoxy, carboxylic acid or carboxylic acid anhydride functional groups. As examples of such polymers, mention may be made of ethylene-alkyl acrylate-maleic anhydride or glycidyl methacrylate terpolymers, such as the Applicant's LOTADER® polymers, or polyolefins grafted by maleic anhydride, such as the Applicant's OREVAC® polymers, and ethylene-alkyl acrylate-(meth)acrylic acid terpolymers. Mention may also be made of polypropylene homopolymers or copolymers grafted by a carboxylic acid anhydride and then condensed with polyamides or monoamine polyamide oligomers.

The MFI of the polyamide and the MFIs of (B1) and (B2) may be chosen with a wide range; however, it is recommended for facilitating the dispersion of (B), that the MFI of the polyamide be higher than that of (B).

For small proportions of (B), for example 10 to 15 parts, it is sufficient to use an unfunctionalized polyolefin (B2). The proportion of (B2) and (B1) in the phase (B) depends on the amount of functional groups present in (B1) and on their reactivity. Advantageously, (B1)/(B2) weight ratios ranging from 5/35 to 15/25 are used. It is also possible to use only a blend of polyolefins (B1) in order to obtain crosslinking.

According to a first preferred embodiment of the polyamide/polyolefin blend, the polyolefin (B) comprises (i) a high-density polyethylene (HDPE) and (ii) a blend of a polyethylene (C1) and of a polymer (C2) chosen from elastomers, very low-density polyethylenes and ethylene copolymers, the (C1)+(C2) blend being cografted by an unsaturated carboxylic acid.

According to a variant of this first embodiment of the invention, the polyolefin (B) comprises (i) a high-density polyethylene (HDPE), (ii) a polymer (C2) chosen from elastomers, very low-density polyethylenes and ethylene copolymers, (C2) being grafted by an unsaturated carboxylic acid, and (iii) a polymer (C′2) chosen from elastomers, very low-density polyethylenes and ethylene copolymers.

According to a second preferred embodiment of the polyamide/polyolefin blend, the polyolefin (B) comprises (i) polypropylene and (ii) a polyolefin which results from the reaction of a polyamide (C4) with a copolymer (C3) comprising propylene and an unsaturated monomer X, which is grafted or copolymerized.

According to a third preferred embodiment of th polyamide/polyolefin blend, the polyolefin (B) comprises (i) a polyethylene of the EVA, LLDEP, VLDPE or metallocene type and (ii) an ethylene/alkyl (meth)acrylate/maleic anhydride copolymer.

According to a fourth preferred embodiment of the polyamide/polyolefin blend, the polyolefin comprises two functionalized polymers comprising at least 50 mol % of ethylene units and able to react to form a crosslinked phase. According to a variant, the polyamide (A) is chosen from blends of (i) a polyamide and (ii) a copolymer having PA-6 blocks and PTMG blocks, and blends of (i) a polyamide and (ii) a copolymer having PA-12 blocks and PTMG blocks, the ratio of the amounts of copolymer to polyamide by weight being between 10/90 and 60/40.

As regards the first embodiment of the preferred polyamide polyolefin blend, the proportions (by weight) are advantageously the following:

60 to 70% of polyamide;

5 to 15% of the cografted blend of (C1) and (C2),

the balance being high-density polyethylene.

As regards the high-density polyethylene, its density is advantageously between 0.940 and 0.965 and the MFI between 0.1 and 5 g/10 min (190° C./2.16 kg).

The polyethylene (C1) may be chosen from the above-mentioned polyethylenes. Advantageously, (C1) is a high-density polyethylene (HDPE) having a density of between 0.940 and 0.965. The MFI of (C1) is between 0.1 and 3 g/10 min (190° C./2.16 kg).

The copolymer (C2) may, for example, be an ethylene/propylene elastomer (EPR) or an ethylene/propylene/diene (EPDM). (C2) may also be a very low-density polyethylene (VLDPE) which is either an ethylene homopolymer or an ethylene/alpha-olefin copolymer. (C2) may also be a copolymer of ethylene with at least one product chosen from (i) unsaturated carboxylic acids, their salts, their esters; (ii) vinyl esters of saturated carboxylic acids; (iii) unsaturated dicarboxylic acids, their salts, their esters, their half-esters and their anhydrides. Advantageously, (C2) is an EPR.

Advantageously, 60 to 95 parts of (C1) per 40 to 5 parts of (C2) are used.

The blend of (C1) and (C2) is grafted with an unsaturated carboxylic acid, that is to say (C1) and (C2) are cografted. It would not be outside the scope of the invention to use a functional derivative of this acid. Examples of unsaturated carboxylic acids are those having from 2 to 20 carbon atoms, such as acrylic, methacrylic, maleic, fumaric and itaconic acids. The functional derivatives of these acids include, for example, the anhydrides, the ester derivatives, the amide derivatives, the imide derivatives and the metal salts (such as the alkali metal salts) of unsaturated carboxylic acids.

Unsaturated dicarboxylic acids having 4 to 10 carbon atoms and their functional derivatives, particularly their anhydrides, are particularly preferred grafting monomers. These grafting monomers comprise, for example, maleic, fumaric, itaconic, citraconic, allylsuccinic, cyclohex-4-ene-1,2-dicarboxylic, 4-methylcyclohex-4-ene-1,2-dicarboxylic, bicyclo[2.2.1] hept-5-ene-2,3-dicarboxylic and x-methylbicyclo[2.2.1]hept-5-ene-2,3-dicarboxylic acids and maleic, itaconic, citraconic, allylsuccinic, cyclohex-4-ene-1,2-dicarboxylic, 4-methylene-cyclohex-4-ene-1,2-dicarboxylic, bicyclo[2.2.1]hept-5-ene-2,3-dicarboxylic and x-methylbicyclo[2.2.1]hept-5-ene-2,2-dicarboxylic anhydrides. Advantageously maleic anhydride is used.

Various known processes can be used to graft a grafting monomer onto the blend of (C1) and (C2). For example, this may be achieved by heating the polymers (C1) and (C2) to a high temperature, about 150° C. to about 300° C., in the presence or absence of a solvent and with or without a radical initiator.

In the graft-modified blend of (C1) and (C2) obtained in the abovementioned manner, the amount of grafting monomer may be chosen appropriately, but it is preferably from 0.01 to 10% and better still from 600 ppm to 2%, with respect to the weight of grafted (C1) and (C2). The amount of grafted monomer is determined by assaying the succinic functional groups by FTIR spectroscopy. The MFI (190° C./2.16 kg) of the cografted (C1) and (C2) is 5 to 30 and preferably 13 to 20 g/10 min.

Advantageously, the cografted (C1) and (C2) blend is such that the MFI₁₀/MFI₂ ratio is greater than 18.5, MFI₁₀ denoting the melt flow index at 190° C. with a load of 10 kg and MFI₂ denoting the melt flow index with a load of 2.16 kg. Advantageously, the MFI₂₀ of the blend of the cografted polymers (C1) and (C2) is less than 24. MFI₂₀ denotes the melt flow index at 190° C. with a load of 21.6 kg.

With regard to the variant of the first preferred embodiment of the polyamide/polyolefin blend, the proportions (by weight) are advantageously the following:

60 to 70% of polyamide,

5 to 10% of grafted (C2),

5 to 10% of (C′2),

the balance being high-density polyethylene.

Advantageously, (C2) is an EPR or an EPDM. Advantageously, (C′2) is an EPR containing 70 to 75% ethylene by weight.

With regard to the second preferred embodiment of the polyamid/polyolefin blend, the proportions (by weight) are advantageously the following:

60 to 70% of polyamide,

20 to 30% of polypropylene,

3 to 10% of a polyolefin which results from the reaction of a polyamide (C4) with a copolymer (C3) comprising propylene and an unsaturated monomer X, grafted or copolymerized.

The MFI (230° C./2.16 kg) of the polypropylene is advantageously less than 0.5 g/10 min and preferably between 0.1 and 0.5 g/10 min. Such products are described in EP 647 681.

The grafted product of this second embodiment of the invention will now be described. Firstly, (C3) is prepared, this being either a copolymer of propylene and an unsaturated monomer X, or a polypropylene onto which an unsaturated monomer X is grafted. X is any unsaturated monomer that can be copolymerized with propylene or grafted onto the polypropylene and having a functional group capable of reacting with a polyamide. This functional group may, for example, be a carboxylic acid, a dicarboxylic acid anhydride or an epoxide. As examples of monomer X, mention may be made of (meth)acrylic acid, maleic anhydride and unsaturated epoxides such as glycidyl (meth)acrylate. Advantageously, maleic anhydride is used. With regard to the grafted polypropylenes, X may be grafted onto polypropylene homopolymers or copolymers, such as ethylene/propylene copolymers consisting predominantly (in moles) of propylene. Advantageously, (C3) is such that X is grafted. The grafting is an operation known per se.

(C4) is a polyamide or a polyamide oligomer. Polyamide oligomers are described in EP 342066 and FR 2291225. The polyamides (or oligomers) (C4) are products resulting from the condensation of the above-mentioned monomers. Polyamide blends may be used. It is advantageous to use PA-6, PA-11, PA-12, a copolyamide having PA-6 units and PA-12 units (PA-6/12) and a copolyamide based on caprolactam, hexamethylenediamine and adipic acid (PA-6/6,6). The polyamides or oligomers (C4) may have acid, amine or monoamine terminal groups. In order for the polyamide to have a monoamine terminal group, all that is required is to use a chain stopper of formula:

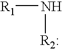

in which:

R₁ is hydrogen or a linear or branched alkyl group containing up to 20 carbon atoms;

R₂ is a linear or branched, alkyl or alkenyl, group having up to 20 carbon atoms, a saturated or unsaturated cycloaliphatic radical, an aromatic radical or a combination of the above. The chain stopper may, for example, be laurylamine or oleylamine.

Advantageously, (C4) is a PA-6, a PA-11 or a PA-12. The proportion by weight of C4 in C3+C4 is advantageously between 0.1 and 60%. The reaction of (C3) with (C4) preferably takes place in the melt state. For example, it is possible to mix (C3) and (C4) in an extruder at a temperature generally between 230 and 250° C. The average residence time of the melt in the extruder may be between 10 seconds and 3 minutes and preferably between 1 and 2 minutes.

With regard to the third preferred embodiment of the polyamide/polyolefin blend, the proportions (by weight) are advantageously the following:

60 to 70% of polyamide,

5 to 15% of an ethylene/alkyl (meth)acrylate/maleic anhydride copolymer,

the balance being a polyethylene of the EVA, LLDPE, VLDPE or metallocene type; advantageously the density of this polyethylene is between 0.870 and 0.925, and the MFI is between 0.1 et 5 g/10 min. (190° C./2.16 kg).

Advantageously, the ethylene/alkyl (meth)acrylate/maleic anhydride copolymers comprise from 0.2 to 10% by weight of maleic anhydride and up to 40% and preferably 5 to 40% by weight of alkyl (meth)acrylate. Their MFIs are between 2 and 100 g/10 min. (190° C./2.16 kg). The alkyl (meth)acrylates have already been mentioned above. The melting point is between 80 and 120° C. These copolymers are commercially available. They are produced by radical polymerization at a pressure that may be between 200 and 2500 bar.

With regard to the fourth preferred embodiment of the polyamide/polyolefin blend, the proportions (by weight) are advantageously the following:

40 to 95% of polyamide,

60 to 5% of a blend of an ethylene/alkyl (meth)acrylate/maleic anhydride copolymer and of an ethylene/alkyl(meth)acrylate/glycidyl methacrylate copolymer.

Advantageously, the ethylene/alkyl (meth)acrylate/maleic anhydride copolymers comprise from 0.2 to 10% by weight of maleic anhydride and up to 40%, and preferably 5 to 40%, by weight of alkyl (meth)acrylate. Their MFIs are between 2 and 100 g/10 min. (190° C./2.16 kg). The alkyl (meth)acrylates have already been described above. The melting point is between 80 and 120° C. These copolymers are commercially available. They are produced by radical polymerization under pressure that can be between 200 and 2500 bar.

The ethylene/alkyl (meth)acrylate/glycidyl methacrylate copolymer may contain up to 40%, advantageously 5 to 40%, by weight of alkyl (meth)acrylate and up to 10%, preferably 0.1 to 8%, by weight of unsaturated epoxide.

Advantageously, the alkyl (meth)acrylate is chosen from methyl (meth)acrylate, ethyl acrylate, n-butyl acrylate, isobutyl acrylate and 2-ethylhexyl acrylate. The amount of alkyl (meth)acrylate is preferably from 20 to 35%. The MFI is advantageously between 5 and 100 g/10 min. (190° C./2.16 kg) and the melting point is between 60 and 110° C. This copolymer can be obtained by radical polymerization of the monomers.

It is possible to add catalysts for accelerating the reaction between the epoxide and anhydride functional groups; among the compounds capable of accelerating the reaction between the epoxide functional group and the anhydride functional group, mention may be made in particular of:

tertiary amines, such as dimethyllaurylamine, dimethylstearylamine, N-butylmorpholine, N,N-dimethylcyclohexylamine, benzyldimethylamine, pyridine, dimethylamino-4-pyridine, methyl-I-imidazole, tetramethylethyl-hydrazine, Ia N,N-dimethylpiperazine, Ia N,N,N′,N′-tetramethyl-1,6-hexane-diamine, a blend of tertiary amines having from 16 to 18 carbon atoms and known as dimethyltallowamine

tertiary phosphines, such as triphenylphosphine;

zinc alkyldithiocarbamates;

acids.

It would not be outside the scope of the invention if part of the ethylene/alkyl (meth)acrylate/maleic anhydride copolymer was replaced with an ethylene/acrylic acid copolymer or an ethylene/maleic anhydride copolymer, the maleic anhydride having been completely or partly hydrolized. These copolymers may also include an alkyl (meth)acrylate. This part may represent up to 30% of the ethylene/alkyl (meth)acrylate/maleic anhydride copolymer.

The material of the inner layer is advantageously chosen from polyamide/polyolefin blends with a polyamide matrix, copolymers having polyamide blocks and polyether blocks, and blends of polyamides with copolymers having polyamide blocks and polyether blocks.

Preferably, in the pol-yamide/polyolefin blends with a polyamide matrix, the polyamide is chosen from PA-6.

As regards the outer layer, the polyamides advantageously have a number-average molecular mass \overline{M}ₙ generally greater than or equal to 12000 and advantageously between 15000 and 50000. Their weight-average molecular mass \overline{M}_{w} is generally greater than 24000 and advantageously between 30000 and 100000. Their inherent viscosity (measured at 20° C. for a specimen consisting of 5×10⁻³ g per cm³ of meta-cresol) is in general greater than 0.9.

As examples of aliphatic polyamides resulting from the condensation of an aliphatic diamine having from 6 to 12 carbon atoms and an aliphatic diacid having from 9 to 12 carbon atoms, mention may be made of:

PA-6,12, resulting from the condensation of hexamethylene diamine and 1,12-dodecanedioic acid;

PA-9,12, resulting from the condensation of the C₉ diamine and 1,12-dodecanedioic acid;

PA-10,10, resulting from the condensation of the C₁₀ diamine and 1,10-decanedioic acid; and

PA-10,12, resulting from the condensation of the C₁₀ diamine and 1,12-dodecanedioic acid.

As regards the 11/12 copolyamides having either more than 90% of nylon-11 units or more than 90% of nylon-12 units, these result from the condensation of 1-aminoundecanoic acid with lauryllactam (or the C₁₂ alpha, omega-amino acid).

Advantageously, the polyamide contains an organic or mineral catalyst which is added during the polycondensation. Preferably, this is phosphoric or hypophosphoric acid. The amount of catalyst may be up to 3000 ppm, and advantageously between 50 and 1000 ppm, relative to the amount of polyamide.

It would not be outside the scope of the invention to use a polyamide blend.

Advantageously, the polyamide is PA-11 or PA-12.

The polyamide may be plasticized. As regards plasticizers, these are chosen from benzene sulfonamide derivatives, such as N-butyl benzene sulfonamide (BBSA), ethyl toluene sulfonamide or N-cyclohexyl toluene sulfonamide; esters of hydroxybenzoic acids, such as 2-ethylhexyl-para-hydroxybenzoate and 2-decylhexyl-para-hydroxybenzoate; esters or ethers of tetrahydrofurfuryl alcohol, like oligoethyleneoxytetra-hydrofurfuryl alcohol; and esters of citric acid and of hydroxy malonic acid such as oligoethyleneoxy malonate. A particularly preferred plasticizier is N-butyl benzene sulfonamide (BBSA). It would not be outside the scope of the invention to use a mixture of plasticizers. The plasticizer may be introduced into the polyamide during the polycondensation or subsequently. The proportion of plasticizer may be between 0 and 30% by weight for between 100% and 70% of polyamide respectively, advantageously 5 and 20%.

As regards the optional tie, this thus denotes any product which allows adhesion of the layers. The tie may be a functionalized polyolefin carrying a carboxylic acid or carboxylic acid anhydride functional group. It may be blended with an unfunctionalized polyolefin. The tie may also be a copolyamide.

To simplify matters, functionalized polyolefins (B1) and unfunctionalized polyolefins (B2) have been described.

As a first example of a tie, mention may be made of the blends comprising:

5 to 30 parts of a polymer (D) which itself comprises a blend of a polyethylene (D1) having a density of between 0.910 and 0.940 and a polymer (D2) chosen from elastomers, very low-density polyethylenes and metallocene polyethylenes, the blend (D1)+(D2) being cografted by an unsaturated carboxylic acid;

95 to 70 parts of a polyethylene (E) having a density of between 0.910 and 0.930;

the blend of (D) and (E) being such that:

its density is between 0.910 and 0.930 and

the content of grafted unsaturated carboxylic acid is between 30 and 10000 ppm;

the MFI (ASTM D 1238: 190° C./2.16 kg) is between 0.1 and 3 g/10 min. MFI denotes the melt flow index.

The density of the tie is advantageously between 0.915 and 0.920. Advantageously, (D1) and (E) are LLDPEs; preferably, they have the same comonomer. This comonomer may be chosen from 1-hexene, 1-octene and 1-butene. The unsaturated carboxylic acid may be replaced with an unsaturated carboxylic acid anhydride.

As a second example of a tie, mention may be made of the blends comprising:

5 to 30 parts of a polymer (F) which itself comprises a blend of a polyethylene (F1) having a density of between 0.935 and 0.980 and a polymer (F2) chosen from elastomers, very low-density polyethylenes and ethylene copolymers, the blend (F1)+(F2) being cografted by an unsaturated carboxylic acid;

95 to 70 parts of a polyethylene (G) having a density of between 0.930 and 0.950;

the blend of (F) and (G) being such that:

its density is between 0.930 and 0.950 and advantageously between 0.930 and 0.940,

the content of grafted unsaturated carboxylic acid is between 30 and 10000 ppm and

the MFI (melt flow index) measured according to ASTM D 1238 is between 5 and 100 g/10 min (190° C./21.6 kg).

The unsaturated carboxylic acid may be replaced with an unsaturated caboxylic acid anhydride.

As a third example of a tie, mention may be made of blends consisting of an HDPE-, LLDPE-, VLDPE- or LDPE-type polyethylene, 5 to 35% of a grafted metallocene polyethylene (i.e. grafted with an unsaturated carboxylic acid or an unsaturated carboxylic acid anhydride) and 0 to 35% of an elastomer, the total being 100%.

As a fourth example of a tie, mention may be made of the blends comprising:

5 to 35 parts of a polymer (S) which itself consists of a blend of 80 to 20 parts of a metallocene polyethylene (S1) having a density of between 0.865 and 0.915 and 20 to 80 parts of a non-metallocene LLDPE polyethylene (S2), the blend (S1)+(S2) being cografted by an unsaturated carboxylic acid;

95 to 65 parts of a polyethylene (T) chosen from polyethylene homopolymers or copolymers, and elastomers;

the blend of (S) and (T) being such that:

the content of grafted unsaturated carboxylic acid is between 30 and 100000 ppm,

the MFI (ASTM D 1238: 190° C./2.16 kg) is between 0.1 and 10 g/10 min. MFI denotes the melt flow index and is expressed in grams per 10 minutes.

The unsaturated carboxylic acid may be replaced with an unsaturated carboxylic acid anhydride.

As regards the copolyamide tie, the copolyamides that can be used in the present invention have a melting point (DIN 53736B standard) of between 60 and 200° C. and their relative solution viscosity may be between 1.3 and 2.2 (DIN 53727 standard; solvent: m-cresol; concentration: 0.5 g/100 ml; temperature: 25° C.; viscometer: Ubbelohde). Their melt rheology is preferably similar to that of the materials of the outer layer and of the inner layer.

The copolyamides come, for example, from the condensation of alpha, omega-aminocarboxylic acids, of lactams or of dicarboxylic acids and diamines.

According to a first type, the copolyamides result from the condensation of at least two alpha, omega-aminocarboxylic acids or of at least two lactams having from 6 to 12 carbon atoms or of a lactam and of an aminocarboxylic acid not having the same number of carbon atoms possibly in the presence of a chain stopper which may, for example, be a monoamine or a diamine or a monocarboxylic acid or a dicarboxylic acid. Among chain stoppers, mention may especially be made of adipic acid, azelaic acid, stearic acid and dodecanediamine. The copolyamides of this first type may also include units which are residues of diamines and dicarboxylic acids.

As examples of dicarboxylic acids, mention may be made of adipic acid, nonanedioic acid, sebacic acid and dodecanedioic acid.

As examples of alpha, omega-aminocarboxylic acids, mention may be made of aminocaproic acid, aminoundecanoic acid and aminododecanoic acid.

As examples of lactams, mention may be made of caprolactam and lauryllactam (2-azacyclotridecanone).

According to a second type, the copolyamides result from the condensation of at least one alpha, omega-aminocarboxylic acid (or a lactam), at least one diamine and at least one dicarboxylic acid. The alpha, omega-aminocarboxylic acid, the lactam and the dicarboxylic acid may be chosen from those mentioned above.

The diamine may be a branched, linear or cyclic aliphatic diamine or else an arylic diamine.

As examples, mention may be made of hexamethylenediamine, piperazine, isophoronediamine (IPD), methylpentamethylenediamine (MPDM), bis(aminocyclohexyl)methane (BACM) and bis(3-methyl-4-aminocyclo-hexyl)methane (BMACM).

The processes for manufacturing the copolyamides are known from the prior art and these copolyamides may be manufactured by polycondensation, for example in an autoclave.

According to a third type, the copolyamides are a blend of a 6/12 copolyamide rich in 6 and of a 6/12 copolyamide rich in 12. As regards the blend of 6/12 copolyamides, one comprising by weight more 6 than 12 and the other more 12 than 6, the 6/12 copolyamide results from the condensation of caprolactam with lauryllactam. It is clear that “6” denotes the units derived from caprolactam and “12” denotes the units derived from lauryllactam. It would not be outside the scope of the invention if caprolactam were to be replaced completely or partly with aminocaproic acid, and likewise, in the case of lauryllactam, this may be replaced with aminododecanoic acid. These copolyamides may include other units provided that the ratios of the proportions of 6 and 12 are respected.

Advantageously, the copolyamide rich in 6 comprises 60 to 90% by weight of 6 for 40 to 10% of 12, respectively.

Advantageously, the copolyamide rich in 12 comprises 60 to 90% by weight of 12 for 40 to 10% of 6, respectively.

As regards the proportions of the copolyamide rich in 6 and of the copolyamide rich in 12, these may be, by weight, from 40/60 to 60/40 and preferably 50/50.

These blends of copolyamides may also include up to 30 parts by weight of other grafted polyolefins or (co)polyamides per 100 parts of the copolyamides rich in 6 and rich in 12.

These copolyamides have a melting point (DIN 53736B standard) of between 60 and 200° C. and their relative solution viscosity may be between 1.3 and 2.2 (DIN 53727; solvent: m-cresol; concentration: 0.5 g/100 ml; temperature: 25° C.; viscometer: Ubbelohde). Their melt rheology is preferably similar to that of the adjacent layers. These products are manufactured by standard polyamide techniques. Processes are described in the following patents: U.S. Pat. No. 4,424,864, U.S. Pat. No. 4,483,975, U.S. Pat. No. 4,774,139, U.S. Pat. No. 5,459,230, U.S. Pat. No. 5489667, U.S. Pat. No. 5,750,232 and U.S. Pat. No. 5,254,641.

As regards the second embodiment of the invention, the inner and outer layers are advantageously made of PA-11 or PA-12 and the interlayer is chosen from the advantageous embodiments of the inner layer of the first embodiment of the invention. The tie in this second embodiment may be chosen from the ties described in the first embodiment.

The inside diameter of the hoses of the present invention may be between 4 and 30 mm and advantageously between 5 and 25 mm. Their thickness may be between 0.5 and 5 mm. In general, the thickness of PA-11 or PA-12 layers are in total thinner than a comparable PA-11 or PA-12 monolayer hose.

These hoses are manufactured by coextrusion. In those which contain a reinforcing braid, this is placed after having extruded the innermost layers and then, on top of this braid, the other layers are coextruded by a device called a “crosshead”. Several interlayers and one or more braids may be incorporated. All these techniques are known per se.

The hoses of the present invention exhibit very good chemical resistance of their outer layer, in particular resistance to zinc chloride. They also exhibit very good mechanical behaviour, in particular allowing them to be connected by means of clamp connectors. Accordingly, they can be used for other purposes, e.g. the transportation of fluids, especially under pressure such as any compressed gas.

It is further to be noted that the polyamide in the polyamide olefins blend is preferably other than PA-11 or PA-12.

The preceding examples can be repeated with similar success by substituting the generically or specifically described reactants and/or operating conditions of this invention for those used in the preceding examples.

The entire disclosures of all applications, patents and publications, cited herein and of corresponding French application No. 02.08185, filed Jul. 1, 2002, are incorporated by reference herein.

From the foregoing description, one skilled in the art can easily ascertain the essential characteristics of this invention and, without departing from the spirit and scope thereof, can make various changes and modifications of the invention to adapt it to various usages and conditions.

1. Multilayer hose suitable for containing compressed air, comprising:
an inner layer chosen from polyamides, polyamide/polyolefin blends with a polyamide matrix, copolymers having polyamide blocks and polyether blocks, and blends of polyamides with copolymers having polyamide blocks and polyether blocks;
an outer layer made of polyamide chosen from PA-11, PA-12, aliphatic polyamides resulting from the condensation of an aliphatic diamine having from 6 to 12 carbon atoms and of an aliphatic diacid having from 9 to 12 carbon atoms, and 11/12 copolyamides either having more than 90% nylon-11 units or more than 90% nylon-12 units.
with the proviso that both the inner and outer layers are not PA-11 or PA-12.

2. Hose according to claim 1, further comprising a reinforcing braid is between the inner layer and the outer layer.

3. Hose according to either of the preceding claims, in which a tie layer is placed between the inner layer and the outer layer.

4. Hose according to any one of the preceding claims, in which other layers are placed between the inner layer and the outer layer.

5. Hose according to any one of the preceding claims, in which the material of the inner layer is chosen from polyamide/polyolefin blend(s) with a polyamide matrix, copolymers having polyamide blocks and polyether blocks, and blends of polyamides with copolymers having polyamide blocks and polyether blocks.

6. Hose according to any one of the preceding claims, in which the outer layer is made of PA-11 or PA-12.

7. Multilayer hose suitable for containing compressed air, comprising:
an inner layer made of polyamide chosen from PA-11, PA-12, aliphatic polyamides resulting from the condensation of an aliphatic diamine having from 6 to 12 carbon atoms and of an aliphatic diacid having from 9 to 12 carbon atoms, and 11/12 copolyamides having either more than 90% nylon-11 units or more than 90% nylon-12 units;
an outer layer made of polyamide which is chosen from the same products as the inner layer and which may be the same or different;
at least one interlayer placed between the inner layer and the outer layer chosen from polyamide/polyolefin blends with a polyamide matrix, copolymers having polyamide blocks and polyether blocks, and blends of polyamides with copolymers having polyamide blocks and polyether blocks.

8. Hose according to claim 7, in which a reinforcing braid is placed between the inner layer and the outer layer.

9. Hose according to claim 7 or 8, in which at least one tie layer is placed between the inner layer and the interlayer and/or between the interlayer and the outer layer.

10. Hose according to any of claims 7 to 9, in which the material of the interlayer is chosen from polyamide/polyolefin blend(s) with a polyamide matrix, copolymers having polyamide blocks and polyether blocks, and blends of polyamides with copolymers having polyamide blocks and polyether blocks.

11. Hose according to any one of claims 7 to 10, in which the material of the inner and outer layers is chosen from PA-11 and PA-12.

12. Hose according to claim 5 or 10, in which, in the polyamide/polyolefin blend with a polyamide matrix, the polyolefin comprises (i) a high-density polyethylene (HDPE) and (ii) a blend of a polyethylene (C1) and a polymer (C2) chosen from elastomers, very low-density polyethylenes, and ethylene copolymers, the (C1)+(C2) blend being cografted by an unsaturated carboxylic acid.

13. Hose according to claim 5 or 10, in which, in the polyamide/polyolefin blend with a polyamide matrix, the polyolefin comprises (i) a high-density polyethylene (HDPE), (ii) a polymer (C2) chosen from elastomers, very low-density polyethylenes and ethylene copolymers, (C2) being grafted by an unsaturated carboxylic acid, and (iii) a polymer (C′2) chosen from elastomers, very low-density polyethylenes and ethylene copolymers.

14. Hose according to claim 5 or 10, in which, in the polyamide/polyolefin blend with a polyamide matrix, the polyolefin comprises (i) polypropylene and (ii) a polyolefin resulting from the reaction of a polyamide (C4) with a copolymer (C3) comprising propylene and a grafted or copolymerized unsaturated monomer X.

15. Hose according to claim 5 or 10, in which, in the polyamide/polyolefin blend with a polyamide matrix, the polyolefin comprises (i) a polyethylene of the EVA, LLDPE, VLDPE or metallocene type and (ii) an ethylene/alkyl (meth)acrylate/maleic anhydride copolymer.

16. Hose according to claim 5 or 10, in which, in the polyamide/polyolefin blend with a polyamide matrix, the polyolefin comprises two functionalized polymers comprising at least 50 mol % of ethylene units and possibly reacting to form a crosslinked phase.

17. Hose according to claim 5 or 10, in which, in the polyamide/polyolefin blend with a polyamide matrix, the polyamide is chosen from blends of (i) polyamide and (ii) copolymer having PA-6 blocks and PTMG blocks, and blends of (i) polyamide and (ii) copolymer having PA-12 blocks and PTMG blocks, the ratio of the amounts of copolymer and of polyamide by weight being between 10/90 and 60/40.

18. Hose according to claim 11, wherein the interlayer is a blend of PA-6 and polyolefin.

19. Hose according to claim 1, further comprising compressed air.

20. Hose according to claim 7, further comprising compressed air.

21. In a method of compressing air and passing said compressed air through a hose, the improvement wherein said hose is a hose according to claim 1.
